(19) United States
(12) Patent Application Publication
(10) Pub. No.: US 2006/0249941 A1
(43) Pub. Date: Nov. 9, 2006

(54) Gas bag for a lateral collision protection device

(75) Inventors: Helge Huebner, Sindelfingen (DE); Manfred Mueller, Deizisau (DE); Ulrich Tschaeschke, Ehningen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/538,365

(22) PCT Filed: Oct. 25, 2003
(86) PCT No.: PCT/EP03/11865

§ 371 Date: May 26, 2006

(30) Foreign Application Priority Data
Dec. 11, 2002 (DE) 102 57 790.0

(51) Int. Cl. B60R 21/26; B60R 21/233

(52) U.S. Cl. 280/743.1; 280/730.2; 280/740

(57) ABSTRACT

A gas bag for a lateral collision protection device has at least one protection chamber which serves to cushion a vehicle occupant in the filled state. The gas bag is filled such as to protect the occupant over a relatively long period of time, without, however, being an obstacle to the rescue of an occupant. For this purpose, the gas bag has an overflow chamber in which a run-off opening is provided, the overflow chamber being connected to the protection chamber via an overflow line.

### BACKGROUND AND SUMMARY OF THE INVENTION

The invention relates to a gas bag for a lateral collision protection device, having at least one protection chamber which serves to cushion a vehicle occupant in the filled state.

It is desirable to use lateral collision protection devices having a gas bag not only for protecting vehicle occupants in the event of a lateral collision, but also for protecting vehicle occupants in the event of the vehicle rolling over. For this purpose, it is necessary for the gas bag to remain filled such as to protect the occupant over a relatively long period of time. The gas which is guided into the gas bag in the case of an accident is therefore not to leave the gas bag again immediately, if possible.

It is known from the prior art, in accordance with DE 298 01 051 U1, to provide a gas bag for a lateral collision protection device with what are known as separate tear-open chambers. The known separate tear-open chambers are initially not filled while the gas bag is being filled. Only after a predefined value of the gas bag internal pressure has been reached are the tear-open chambers opened and can gas flow into the previously empty chambers. As a result, kinetic energy of the penetrating body is converted, the quantity of gas in the gas bag remaining constant overall, with the result that the gas bag also continues to be available for subsequent use.

U.S. Pat. No. 6,213,499 B1 has disclosed a gas bag having a front and a rear protection chamber. The two protection chambers are connected to one another via a valve device. The valve device is configured in such a way that the gas can flow through only in one direction. WO 99/10207 A discloses a gas bag having a plurality of gas chambers which are connected to one another via various transfer lines and openings. DE 299 07 622 U1 has disclosed a gas bag having a plurality of protection chambers which are arranged behind one another. The individual protection chambers are connected to one another via constrictions.

However, it is a disadvantage of the known embodiment that the gas bag which is still filled can be an obstacle to the rescue of an occupant.

Against this background, the present invention is based on the object of providing a gas bag for a lateral collision protection device, in which the gas bag is filled such as to protect the occupant over a relatively long period of time, without, however, being an obstacle to the rescue of an occupant.

According to the invention, this object is achieved by a gas bag for a lateral collision protection device, having at least one protection chamber which serves to cushion a vehicle occupant in the filled state, wherein the gas bag has an overflow chamber in which a run-off opening is provided, the overflow chamber being connected to the protection chamber via an overflow line.

According to the above, the gas bag according to the invention for a lateral collision protection device is distinguished by the fact that, in addition to a protection chamber which serves to cushion a vehicle occupant, it has an additional chamber in which a run-off opening is provided. According to the invention, the protection chamber and the overflow chamber are connected to one another via an overflow line. The gas bag according to the invention has the advantage that the run-off process of the gas which is situated in the gas bag is delayed by the arrangement according to the invention. The gas is namely guided first into the protection chambers, as a result of which the gas bag develops its protective effect. Subsequently, the gas flows via the overflow line into the overflow chamber, where it leaves the gas bag via the run-off opening. Depending on how large the cross section of the run-off opening and the cross section of the overflow line are selected to be, the gas flows out of the protection chamber more rapidly or more slowly. The time in which the gas bag is filled in a functionally appropriate way can be set very simply by the run-off speed of the gas. The arrangement according to the invention thus makes a gas bag for a lateral collision protection device available, which gas bag is filled such as to protect the occupant for a relatively long period of time, for example for the period of time it takes a vehicle to roll over, and at the same time is deflated again for the rescue of an occupant.

According to one embodiment, the gas bag can comprise a coated or laminated woven fabric. The use of a woven fabric of this type has the advantage that the gas which is situated in the gas bag cannot escape through the woven fabric. This aids the situation where the gas bag remains filled such as to protect the occupant over a relatively long period of time.

Gas generators can be used for filling the gas bag, the gas of which cools only a little during relaxation. A pressure which is as constant as possible in the gas bag over a relatively long period of time is ensured by the fact that the gas initially retains its temperature.

It is conceivable for the gas bag according to the invention to have a plurality of overflow chambers. The latter can be arranged at mutually remote positions in the gas bag, with the result that uniform running off is ensured in all regions of the gas bag.

A plurality of overflow lines can lead to one overflow chamber. If these overflow lines are connected to different protection chamber regions, this arrangement likewise assists uniform running off of the gas which is situated in the gas bag. This ensures that the gas bag is deflated again for the rescue of an occupant.

Furthermore, the run-off speed can be set by virtue of the fact that the magnitude of the overflow line and the magnitude of the run-off opening are adapted to one another. One possible example of a ratio of the magnitude of the cross section of the overflow line to the magnitude of the run-off opening is 1:1.

In the following text, the invention will be explained in greater detail using the exemplary embodiment shown in the drawings.

### BRIEF DESCRIPTION OF THE DRAWINGS

FIG. 1 shows a side view of a gas bag according to the invention having two overflow chambers, and

FIG. 2 shows a detailed view of the gas bag according to the invention shown in FIG. 1.

### DETAILED DESCRIPTION OF THE DRAWINGS

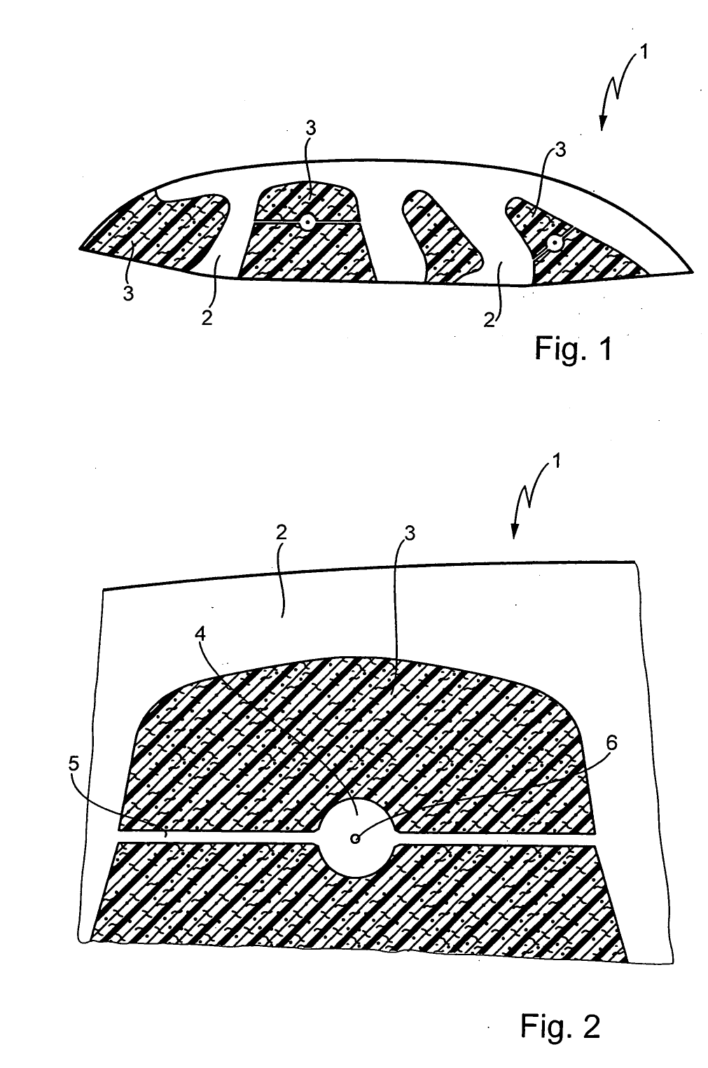

FIG. 1 shows a gas bag 1 for a lateral collision protection device. The gas bag 1 is what is known as a window bag, which unfolds in front of the side windows in a vehicle in the event of an impact and thus represents an impact protection system for the shoulder and head regions of vehicle occupants. The gas bag 1 is distinguished by different regions. Regions are thus provided, what are known as protection chambers 2, which are filled with gas. Secondly, the gas bag has regions 3 into which no gas can flow during filling. The protection chambers 2 are arranged where the probability of contact with a body part of a vehicle occupant is greatest.

As shown in FIG. 2, the gas bag 1 has overflow chambers 4 in addition to the protection chambers 2 and the nonfilled regions 3. The overflow chamber 4 is connected to the protection chambers 2 via two overflow lines 5. It has a run-off opening 6. In the exemplary embodiment shown, the overflow chamber 4 is arranged in the nonfilled region 3. This nonfilled region 3 can be of either sewn or woven configuration.

1-6. (canceled)

7. A gas bag for a lateral collision protection device comprising:
at least one protection chamber which serves to cushion a vehicle occupant in a filled state,
an overflow chamber which is connected to the protection chamber via an overflow line, and
a run-off opening is provided in the overflow chamber,
wherein the gas which is situated in the gas bag flows from the protection chamber via the overflow line into the overflow chamber and leaves the gas bag there via the run-off opening.

8. The gas bag as claimed in claim 7, wherein the gas bag comprises coated and/or laminated woven fabric.

9. The gas bag as claimed in claim 7, wherein the gas bag has a plurality of overflow chambers.

10. The gas bag as claimed in claim 7, wherein the overflow chamber is connected to the protection chamber via a plurality of overflow lines.

11. The gas bag as claimed in claim 9, wherein the magnitude of the cross section of the overflow line and the magnitude of the run-off opening are adapted to one another.

12. The gas bag as claimed in claim 11, wherein the cross-section of the overflow line is approximately the same as the cross-section of the run-off opening.
